(19) United States
(12) Patent Application Publication
(10) Pub. No.: US 2016/0342476 A1
(43) Pub. Date: Nov. 24, 2016

(54) SOLID STATE DRIVE OPERATIONS

(71) Applicant: HEWLETT PACKARD ENTERPRISE DEVELOPMENT LP, Houston, TX (US)

(72) Inventors: Siamak Nazari, Fremont, CA (US); Danil Aaron Harbaugh, Bellevue, WA (US); William Joshua Price, Fremont, CA (US); Danyaal Masood Khan, Fremont, CA (US); Faris Hindi, Fremont, CA (US)

(21) Appl. No.: 15/114,912

(22) PCT Filed: Mar. 20, 2014
(86) PCT No.: PCT/US2014/031327

§ 371 Date: Jul. 28, 2016

(51) Int. Cl. G06F 11/10; G06F 11/20; G06F 12/02

(52) U.S. Cl. CPC G06F 11/1092; G06F 12/0246; G06F 11/1008; G06F 11/108; G06F 11/2094; G06F 2212/2022; G06F 2212/214

(57) ABSTRACT

A data storage drive and a controller communicatively coupled to the data storage drive. The data storage drive includes a first region of storage space and at least a second region of storage space. The storage drive to reserve the first region of storage space for over-provisioning operations. The controller is to instruct the data storage drive to use the second region of storage space for over-provisioning operations.

### BACKGROUND

Solid State Drives (SSDs) are non-volatile data storage devices that are used for persistent data storage, but unlike hard disks drives, contain no moving parts. Some SSD drives use flash memory, which can retain data without being powered. One drawback of flash memory is that each memory cell of a flash-based SSD can be written only a limited number of times before the memory cell fails. To extend the life of flash-based SSDs, various techniques are employed to extend the life of drive, such as wear leveling, which spreads write operations more evenly across the memory cells of the drive.

### BRIEF DESCRIPTION OF THE DRAWINGS

Certain exemplary embodiments are described in the following detailed description and in reference to the drawings, in which:

FIG. 1 is a block diagram of a storage system with data storage drives that can be configured to use spare storage space for over-provisioning;

FIG. 2 is a block diagram showing two example memory allocations for a drive, such as one of the drives shown in FIG. 1;

FIG. 3 is a process flow diagram of a method of operating a data storage drive; and

FIG. 4 is a block diagram showing a tangible, non-transitory, computer-readable medium that stores code configured to operate a data storage drive.

### DETAILED DESCRIPTION OF SPECIFIC EMBODIMENTS

One characteristic of flash memory is that flash memory cells cannot be directly overwritten. Thus, when data is written to an SSD memory cell, the cell must first be erased and then written. In some cases, this may result in two writes for each actual bit of data to be stored to the device. In most flash memory, data is written in units called pages, but data is erased in larger units called blocks. If enough data within a block is unneeded (i.e., stale pages), the entire block is erased and any good data in the block is re-written to a new block. The remainder of the new block that is left over can be written with new data. This process of erasing blocks and moving good data to new blocks is referred to as “garbage collection.” Most SSDs include some amount of storage space that is reserved for garbage collection, wear-leveling, and remapping bad blocks, among other things. The difference between the physical amount of storage capacity and the logical capacity presented to the user is referred to as over-provisioning.

Techniques such as wear-leveling and garbage collection effect the drive's write amplification, which is a phenomenon in which the actual amount of physical information written within the drive is a multiple of the logical amount of data intended to be written. The higher the write amplification of a drive, the more writes that the cells of the drive will experience for a given amount of data storage usage.

The present disclosure provides techniques for reducing the write-amplification of a flash drive by increasing the amount of storage space on the drive available for over-provisioning. Providing more storage space for over-provisioning improves the efficiencies of the wear-leveling and garbage collection algorithms, which have a direct effect on write amplification.

Many storage systems utilize an array of drives and provide fault tolerance by storing data with redundancy. The failure of a drive can cause a controller to identify a drive as failed and initiate a spare rebuild process that regenerates the data of the failed drive from the other drives. Meanwhile, the bad drive can be replaced by the customer. In such a system, a certain amount of the system's storage space is reserved for the spare rebuild process. For example, some systems may include one or more whole drives that are reserved as spare drives to be used in the event of drive a failure. In some systems, the storage resources used for spare rebuild are distributed across several drives. In such a storage system, multiple drives of the storage system can include a certain amount of storage space that is reserved as spare storage, while most of the remaining storage space is free space, which is used for storing host data.

As mentioned above, the write amplification of a storage drive can be reduced by providing more storage space for over-provisioning. The techniques disclosed herein provide more storage space for over-provisioning by enabling a drive to use the storage space designated as “spare” storage space for over-provisioning when not in use for a spare rebuild operation. Providing more storage for over-provisioning reduces the write amplification of the drive, which reduces the overall number of writes the memory cells of the drive experience and thereby extends the useful life of the drive.

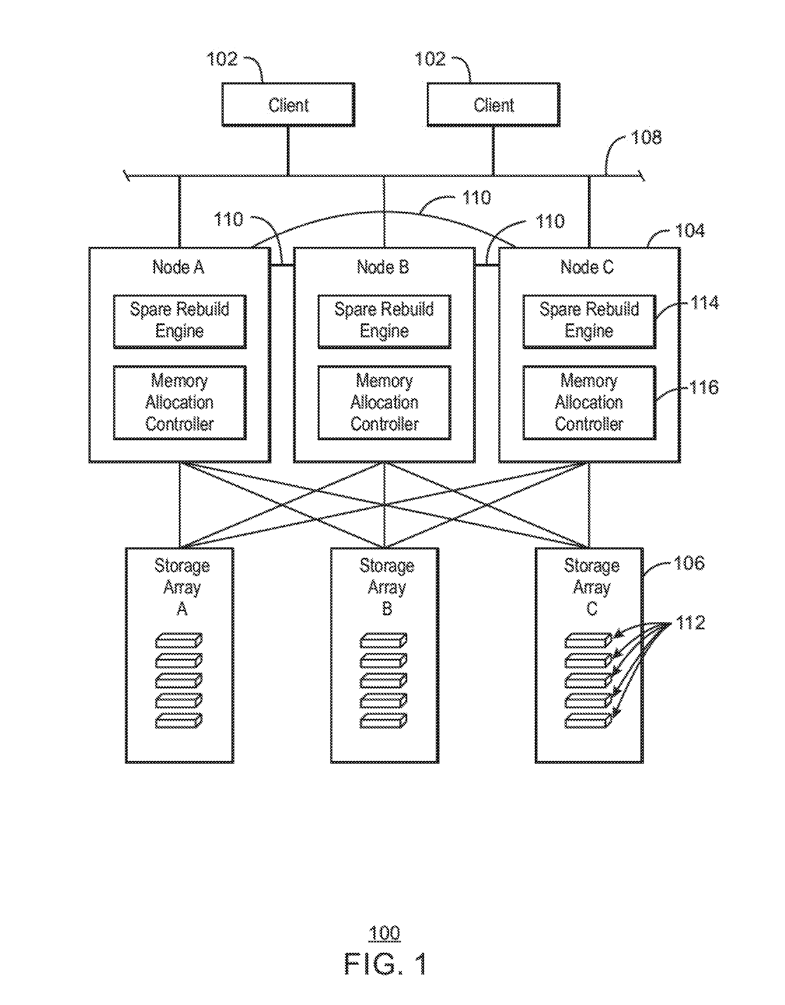

FIG. 1 is a block diagram of a storage system with data storage drives that can be configured to use spare storage space for over-provisioning. It will be appreciated that the storage system 100 shown in FIG. 1 is only one example of a storage system in accordance with embodiments. In an actual implementation, the storage system 100 may include various additional storage devices and networks, which may be interconnected in any suitable fashion, depending on the design considerations of a particular implementation. For example, a large storage system will often have many more client computers and storage devices than shown in this illustration.

The storage system 100 provides data storage resources to any number of client computers 102, which may be general purpose computers, workstations, mobile computing devices, and the like. The storage system 100 includes storage controllers, referred to herein as nodes 104. The storage system 100 also includes storage arrays 106, which are controlled by the nodes 104. The client computers 102 can be coupled to the storage system 100 directly or through a network 108, which may be a local area network (LAN), wide area network (WAN), a storage area network (SAN), or other suitable type of network.

The client computers 102 can access the storage space of the storage arrays 106 by sending Input/Output (I/O) requests, including write requests and read requests, to the nodes 104. The nodes 104 process the I/O requests so that user data is written to or read from the appropriate storage locations in the storage arrays 106. As used herein, the term “user data” refers to data that a person might use in the course of business, performing a job function, or for personal use, such as business data and reports, Web pages, user files, image files, video files, audio files, software applications, or any other similar type of data that that a user may wish to save to long term storage. Each of the nodes 104 can be communicatively coupled to each of the storage arrays 106. Each node 104 can also be communicatively coupled to each other node by an inter-node communication network 110.

The storage arrays 106 may include various types of persistent storage, including solid state drives 112, which may be referred to herein simply as drives 112. In some examples, the drives 112 are flash drives. However, the drives 112 may also use other types of persistent memory, including resistive memory, for example. Each storage array 106 includes multiple drives 112, each of which is configured so that a certain amount of storage space on each drive is designated as spare storage to be used for spare rebuild operations. The amount of storage space designated as spare storage may be a parameter set by the nodes 104. The storage network system 100 may also include additional storage devices in addition to what is shown in FIG. 1.

Each node 104 can include a spare rebuild engine 114 that performs spare rebuild operations. The spare rebuild engine 114 can be implemented in hardware or a combination of hardware and programming code. For example, the spare rebuild engine 114 can include a non-transitory, computer-readable medium for storing instructions, one or more processors for executing the instructions, or a combination thereof. In some examples, the spare rebuild engine 114 is implemented as computer-readable instructions stored on an integrated circuit such as an Application Specific Integrated Circuit (ASIC), a Field Programmable Gate Array (FPGA), or other type of processor.

The spare rebuild engine 114 is configured to rebuild drive data. If the node 104 detects a failure condition, the node 104 can trigger the spare rebuild engine 114 to conduct a spare rebuild operation. During the spare rebuild operation, the data of the failed drive is re-created on the storage space designated as spare storage space. The spare rebuild engine 114 can use any suitable technique for rebuilding the data of the failed drive on the spare storage space.

Each node 104 can also include a memory allocation controller 116 that controls the allocation of storage space in the storage arrays 106 between spare storage and over-provisioning storage. The memory allocation controller 116 can be implemented as part of the spare rebuild engine 114 or as a separate component. Each node 104 controls the memory allocation for a certain sub-set of the drives 112. In some examples, the storage system 100 can be configured so that each node 104 may control all the drives of a specific storage array 106. For example, node A can be configured to control the drives 112 in storage array A, node B can be configured to control the drives 112 in storage array B, and node C can be configured to control the drives 112 in storage array C. Other arrangements are also possible depending on the design considerations of a particular implementation. Additionally, certain details of the storage system configuration can be specified by an administrator, including the amount of storage space used for spare storage and which nodes 104 control which drives 112, for example.

As mentioned above, several or all of the drives 112 have a certain amount of storage space that is designated as spare storage space. During normal operation of a storage array 106 the memory allocation controller 116 of the corresponding node 104 can instruct each drive 112 under its control to use the spare storage for over-provisioning. If a spare rebuild operation is initiated, the memory allocation controller 116 instructs those drives 112 involved in the spare rebuild operation to stop using the spare storage space for over-provisioning, and the space becomes available for the spare rebuild operation. When the spare rebuild operation is complete and the spare storage space is no longer being used, the memory allocation controller 116 instructs the drives 112 to use the spare storage space for over-provisioning again.

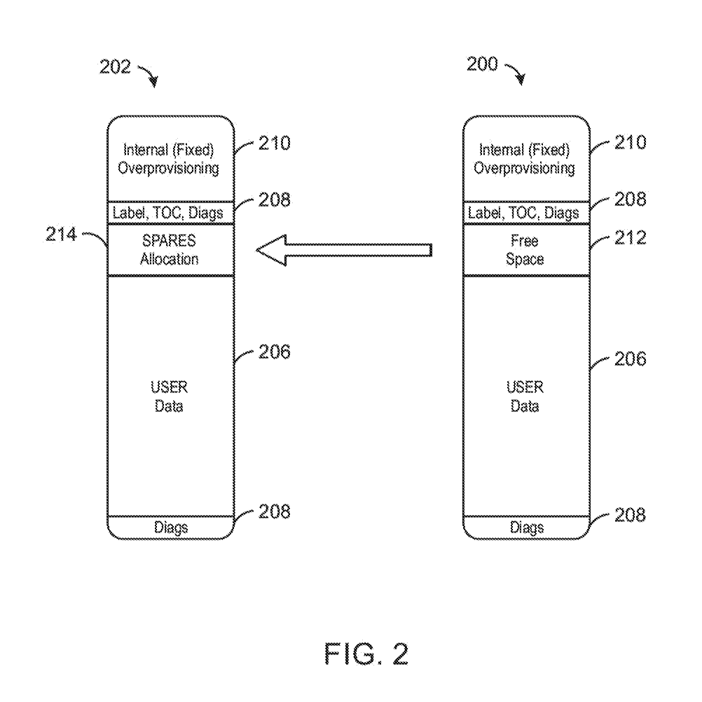

FIG. 2 is a block diagram showing two example memory allocations for a drive, such as one of the drives shown in FIG. 1. Memory map 200 shows a memory allocation for a drive 112 during normal operation, and memory map 202 shows the memory allocation for a drive 112 during a spare rebuild operation. As shown in FIG. 2, some portion of the available storage space is mapped as a user data region 206. The user data region 206 represents storage space that exposed to the file system and is visible to a client computer 102. A user of the client computer 102 can store data to and receive data from the user data region 206.

Additionally, some portion of the storage space is mapped for internal use by the storage system 100. Examples of this use could be, but is not limited to, drive identification labels, storage system table of content identifiers, or diagnostic and test areas.

Some portion of the storage space is mapped as an internal over-provisioning region 210. The internal over-provisioning region 210 is a reserved by the drive itself for over-provisioning processes such as garbage collection, wear-leveling, bad block remapping, and the like. The over-provisioning processes are performed by the drive itself. For example, a processor of the drive can run firmware programmed for the over-provisioning processes. In some examples, the over-provisioning region 210 is not visible to or accessible by an external device storage controller, such as the nodes 104 of FIG. 1. In this sense, the over-provisioning region 210 is hidden storage space. The size of the internal over-provisioning region 210 may be determined by the drive manufacturer.

As shown in the memory map 202, some portion of the drive's visible storage space is designated as a spare storage space region 214. The spare storage space region 214 is accessible to the nodes 104 and is reserved by and controlled by the nodes 104. The configuration of the spare storage space region 214 can be determined by an administrator of the storage system 100. For example, the administrator can specify how much spare storage space is set aside by each drive. This same region is shown in memory map 200 as a free space 212. At the time that the drive is brought on-line, the node in control of the drive can instruct the drive to use the spare storage space region 214 as free space 212 to be used for over-provisioning. The drive firmware is configured to be able to receive an instruction to use normally visible storage space for over-provisioning. Thus, the storage space used for over-provisioning is not fixed by the manufacturer of the drive. If a spare rebuild operation is initiated, the node in control of the drive can reclaim the free-space 212 by instructing the drive to stop using the spare storage space region 214 for over-provisioning.

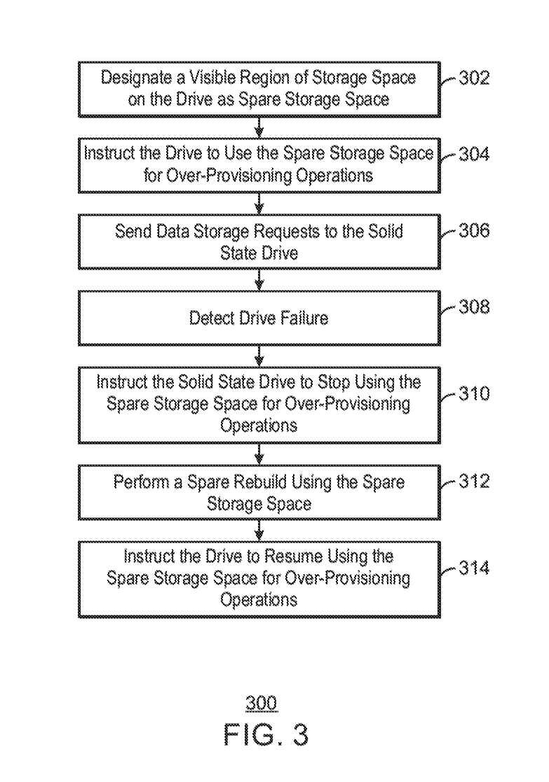

FIG. 3 is a process flow diagram of a method of operating a data storage drive. The method 300 can be performed by a storage controller such as one of the nodes 104 shown in FIG. 1. The storage drive can be one of the drives 112 shown in FIG. 1.

At block 302, a visible region of storage space on the drive is designated as spare storage space. This operation can be performed in accordance with input received from a system administrator.

At block 304, the drive is instructed to use the spare storage space for over-provisioning operations. As explained above, over-provisioning operations are operations that reduce write amplification in a drive and extend the useful life of the drive. Such over-provisioning operations include wear-leveling and garbage collecting.

At block 306, data storage requests are sent to the drive. The data storage requests include write requests and read requests that are received during the regular operation of the storage system. For example, the data storage requests may be I/O requests received from a client computer requesting user data to be stored to a region of the drive reserved for user data. During the regular operation of the storage system, the drive will perform over-provisioning operations using both the spare storage space and a fixed internal storage space that is reserved by the drive for over-provisioning operations. In some examples, the storage space that is reserved by the drive for over-provisioning operations is a hidden storage space that is not accessible to the external storage controller.

At block 308, some event or action occurs that triggers the use of the spare storage space. For example, a failure of a drive may be detected or an administrator may perform an action that triggers the need for spare storage space.

At block 310, the solid state drive is instructed to stop using all or a portion of the spare storage space for over-provisioning operations. The drive will then stop using the spare storage space for over-provisioning operations and move any needed data from the spare storage space to another region of the drive, such as the hidden storage space. In some examples, after the drive has released the spare storage space and moved any needed data, the drive may send an acknowledgment to the controller indicating that the spare storage space is available.

At block 312, the spare storage space is used to perform a spare rebuild. In some examples, the controller may wait for the drive to acknowledge that the spare storage space is available.

At block 314, the spare rebuild is finished, and any data that was stored to the spare storage space has been erased or is no longer needed. At this time, the drive is instructed to resume using the spare storage space for over-provisioning operations.

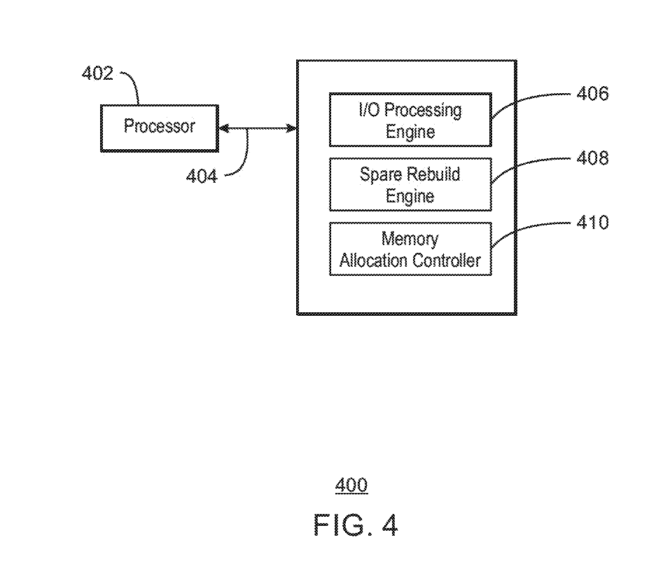

FIG. 4 is a block diagram showing a tangible, non-transitory, computer-readable medium that stores code configured to operate a data storage drive. The computer-readable medium is referred to by the reference number 400. The computer-readable medium 400 can include RAM, a hard disk drive, an array of hard disk drives, an optical drive, an array of optical drives, a non-volatile memory, a flash drive, a digital versatile disk (DVD), or a compact disk (CD), among others. The computer-readable medium 400 may be accessed by a processor 402 over a computer bus 404. Furthermore, the computer-readable medium 400 may include code configured to perform the methods described herein. For example, the computer readable medium 400 may include firmware that is executed by a storage controller such as the nodes 104 of FIG. 1.

The various software components discussed herein may be stored on the computer-readable medium 400. A region 406 on the computer-readable medium 400 can include an I/O processing engine that processes I/O requests received from a client computer. For example, processing I/O requests can include storing data to a storage drive or retrieving data from a storage drive and sending it to a client computer that requested it. A region 408 can include a spare rebuild engine to rebuild the data of a failed disk on spare storage space of one or more drives. A region 410 can include a memory allocation controller configured to designate a visible region of storage space on a drive as spare storage space. The memory allocation controller can also instruct the drive to use the spare storage space for the over-provisioning operations when not being used for a spare rebuild operation. Although shown as contiguous blocks, the software components can be stored in any order or configuration. For example, if the tangible, non-transitory, computer-readable medium is a hard drive, the software components can be stored in non-contiguous, or even overlapping, sectors.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed is:

1. A system comprising:
a data storage drive comprising a first region of storage space and at least a second region of storage space, wherein the storage drive is to reserve the first region of storage space for over-provisioning operations; and
a controller communicatively coupled to the data storage drive, the controller to designate a second region of storage space as spare storage space for use in data rebuild operations and instruct the data storage drive to use the second region of storage space for over-provisioning operations.

2. The system of claim 1, the data storage drive comprising a third region of storage space to be used for host data.

3. The system of claim 1, wherein, if the controller initiates a spare rebuild operation, the controller is to instruct the drive to stop using the second region of storage space for over-provisioning, and the controller is to use the second region of storage space for the spare rebuild operation.

4. The system of claim 3, wherein, at the conclusion of the spare rebuild operation, the controller is to instruct the data storage drive to use the second region of storage space for over-provisioning operations.

5. The system of claim 1, wherein the first region of storage space is not accessible to the controller and the second region of storage space is accessible to the controller.

6. The system of claim 1, wherein the data storage drive is a solid state drive comprising flash memory.

7. The system of claim 1, wherein the data storage drive is one drive of a drive array comprising a plurality of drives, and each of the plurality of drives includes spare storage space that is used for spare rebuild operations and is also used for over-provisioning operations when not being used for spare rebuild operations.

8. A method comprising:
sending data storage requests to a solid state drive, the solid state drive to perform over-provisioning operations using at least a first region of the storage space;
designating a second region of storage space of the solid state drive as spare storage space; and
instructing the solid state drive to use the second region of storage space for over-provisioning operations.

9. The method of claim 8, comprising instructing the solid state drive to stop using the second region of storage space for over-provisioning operations, and initiating a spare rebuild operation.

10. The method of claim 9 comprising, during the spare rebuild operation, rebuilding data of a failed drive at least partially on the second region of storage space.

11. The method of claim 10 comprising, after the spare rebuild operation is finished, instructing the solid state drive to again use the second region of storage space for over-provisioning operations.

12. A tangible, non-transitory, computer-readable medium comprising instructions that direct a processor to:
send data storage requests to a solid state drive, the solid state drive to perform over-provisioning operations using a hidden region of the storage space;
designate a visible region of storage space on the solid state drive as spare storage space; and
instruct the solid state drive to use the spare storage space for the over-provisioning operations.

13. The computer-readable medium of claim 12, comprising instructions that direct the processor to send an instruction to the solid state drive to stop using the spare storage space for the over-provisioning operations.

14. The computer-readable medium of claim 12, comprising instructions that direct the processor to, after the solid state drive has stopped using the spare storage space for the over-provisioning operations, write data to the spare storage space during a spare rebuild operation.

15. The computer-readable medium of claim 12, wherein the computer-readable medium is included in a storage controller node of a storage area network.
